(19) United States
(12) Patent Application Publication
(10) Pub. No.: US 2016/0019566 A1
(43) Pub. Date: Jan. 21, 2016

(54) MOBILE SOCIAL NETWORK ANALYSIS SYSTEM AND METHOD

(71) Applicant: ABIBA SYSTEMS PRIVATE LIMITED, Karnataka (IN)

(72) Inventor: Jay Bharatheesh SIMHA, BANGALORE (IN)

(21) Appl. No.: 14/773,306

(22) PCT Filed: Mar. 5, 2014
(86) PCT No.: PCT/IN2014/000146

§ 371 Date: Sep. 4, 2015

(30) Foreign Application Priority Data
Mar. 5, 2013 (IN) 953/CHE/2013

(51) Int. Cl. G06Q 30/02; G06Q 50/00; G06F 17/30

(52) U.S. Cl. CPC G06Q 30/0202; G06F 17/3053; G06Q 50/01

(57) ABSTRACT

The present invention provides a method and system for mobile social network analytics. The entire subscriber base forms a social segment for any telecom company. This is commonly known as telecom call graph. The present invention constructs social segments and computes social metrics of both segments and individual subscribers in the telecom network. The present invention further analyses the social segment graph and assigns segment score and churn propensity score to each subscriber using a mobile social network analytics system. The input to the mobile social network analytics system is CDR from external sources and information from campaigns, demographics and so on. The mobile social network analytics system processes the CDR, the other information and outputs segment score and churn score.

### RELATED APPLICATION

Benefit is claimed to Indian Provisional Application No. 953/CHE/2013 titled “MOBILE SOCIAL NETWORK ANALYSIS SYSTEM AND METHOD” filed on 5 Mar. 2013, which is herein incorporated in its entirety by reference for all purposes.

### FIELD OF THE INVENTION

The present invention generally relates to the field of mobile network analytics, and more particularly relates to a system and method for analysing mobile social network.

### BACKGROUND OF THE INVENTION

A successful telecommunications operator has to be able to accomplish three tasks: 1) acquire new subscribers, 2) retain existing subscribers and 3) make a profit on the service provided. One of the most common problems faced by the telecommunications operator is churning. Churning refers to the situation where subscribers discontinue mobile services and avail mobile services from another telecommunication operator. The causes of churn include the opportunity to pay a lower rate, the chance to get something for free (e.g., free voice mail or a rebate), and service dissatisfaction. While it is important to understand the causes of churning, from a business standpoint, understanding which particular customers are most likely to churn is even more important.

A key asset of a telecommunications operator is the knowledge that it has about its customers. Having deep customer knowledge allows the operator to optimize the relationship with its customers, and increase customer satisfaction by means of, e.g., personalized services or attractive commercial offerings. In addition, this focus on the customers will enable the operator to maintain sustainable leadership in such a mature and competitive market.

### SUMMARY

An objective of present invention is to provide a system for analysing mobile social network.

Another objective of the present invention is to provide a method for generating statistics of social segments and churn prediction scores.

Further objective of the present invention is to provide a method for generating a social network analytics model and computing a churn propensity score.

An embodiment of the present invention describes a mobile social network analytic system, which comprises a data integration module configured for receiving and integrating a set of input data, a social network analytics modeller coupled to the data integration module for processing the integrated data and deriving social segments and computing churn prediction scores and a social network analytics visualizer coupled to the social network analytics modeller and a data storage for displaying and analysing the social segments and churning prediction scores. The input data comprises call detail record (CDR) from external source, and one or more information from campaigns and demographics. The system according to present invention further comprises one or more external sources for providing input data to the data integration module. The external source comprises at least one of a data warehouse and core file database. The data storage is coupled to the social network analytics modeller for receiving and storing the social segments and churn prediction scores.

Another embodiment of the present invention describes a method of generating statistics of social segments and churn prediction scores. The method comprises integrating a set of input data received from an external source to generate a graph, dividing the entire space of the graph into a number of grids, computing coordinates associated with each of the grids, determining grid coordinates associated with each subscriber, determining the grids associated with the subscribers based on the determined grid coordinates, updating a segment tag associated with each subscriber with the grid number, merging the segment with another segment when number of subscribers per segment being less than predetermined number of subscribers and computing statistics associated with each grid in the graph space when number of subscribers per segment being not less than predetermined number of subscribers. The set of input data comprises call detail record (CDR) from external source, and one or more information from campaigns and demographics.

Further embodiment of the present invention describes a method of generating a social network analytics model and computing a churn propensity score by the social network analytics system. The method comprises obtaining social network analytic data and behavioural data from a data storage and the data warehouse, integrating the social network analytics data and the behavioural data according to user defined configuration, generating one or more models based on the selection of variables, evaluating the social network analytic model based on a pre-set criteria, determining whether the social network analytic model conforms to the pre-set criteria, rebuilding the social network analytics model by adding new features when the determination fails to conform the pre-set criteria, storing the social network analytics model in the data storage when the determination conforms the pre-set criteria and assigning a score to new subscribers using the stored social network analytics model. The pre-set criteria comprises classification accuracy, true positive to false positive ratio, lift and decline effectiveness.

### BRIEF DESCRIPTION OF THE ACCOMPANYING DRAWINGS

The aforementioned aspects and other features of the present invention will be explained in the following description, taken in conjunction with the accompanying drawings, wherein:

FIG. 1 illustrates a schematic representation illustrating a mobile social network analytics system, according to one embodiment.

FIG. 2 illustrates a mobile social network analytic system, according to one embodiment.

FIG. 3 illustrates a process flowchart illustrating an exemplary method of generating statistics of social segments from the integrated data by the social network analytics modeller, according to one embodiment.

FIG. 4 illustrates a screenshot depicting representation of a social segment statistics at a macro level.

FIG. 5 illustrates a screenshot depicting representation of a social segment statistics at a subscriber level.

FIG. 6 illustrates a screenshot of a grid view representation of a social segment statistics at a subscriber level.

FIG. 7 illustrates a screenshot of a heat map view representation of social segment statistics.

FIG. 8 illustrates a process flowchart illustrating an exemplary method of generating a social network analytics model and computing a churn propensity score by the social network analytics modeller, according to one embodiment.

### DETAILED DESCRIPTION OF THE INVENTION

The embodiments of the present invention will now be described in detail with reference to the accompanying drawings. However, the present invention is not limited to the embodiments. The present invention can be modified in various forms. Thus, the embodiments of the present invention are only provided to explain more clearly the present invention to the ordinarily skilled in the art of the present invention. In the accompanying drawings, like reference numerals are used to indicate like components.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention provides a method and system for mobile social network analytics. The entire subscriber base forms a social segment for any telecom company. This is commonly known as telecom call graph. The entire subscriber base is a rich source of both revenue and social value. The present invention constructs social segments and computes social metrics of both segments and individual subscribers in the telecom network. The present invention analyses the social segment graph and assigns segment score and churn propensity score to each subscriber.

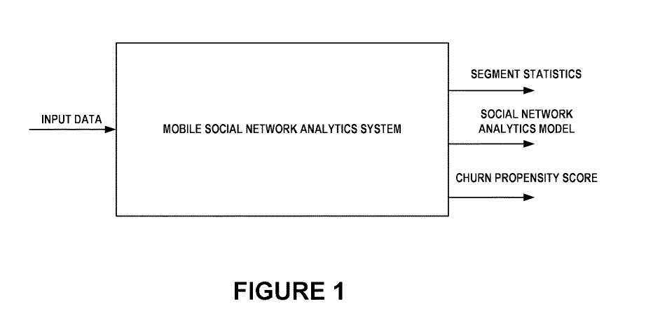

FIG. 1 is a schematic representation illustrating a mobile social network analytics system, according to one embodiment. The system receives a set of input data such as call detail record (CDR) from external sources and information from campaigns, demographics and so on. The mobile social network analytics system processes the CDR, the other information and outputs segment score and churn score. In some embodiments, the mobile social analytics system may a server or a computing device which obtains the CDR and other information stored in a database and process the CDR and other information using a processor. Accordingly, the mobile social analytics system may output the segment score and the churn score on the display. In other embodiments, the mobile social analytics system may be implemented on a handheld device such as a tablet or a smartphone.

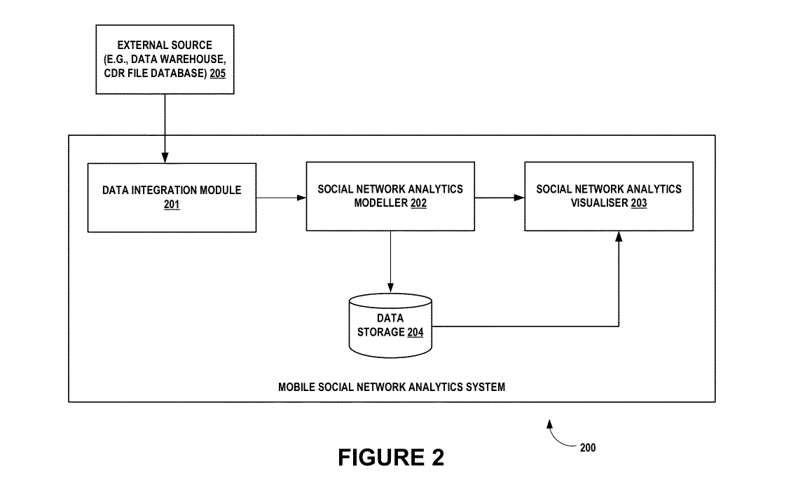

FIG. 2 illustrates a mobile social network analytic system 200, according to one embodiment. The system 200 comprises a data integration module 201, a social network analytics modeller 202, and a social network analytics visualiser 203.

The data integration module 201 is configured for receiving and integrating a set of input data. The social network analytics modeller 202 is coupled to the data integration module 201 for processing the integrated data and deriving social segments and computing churn prediction scores. The social network analytics visualiser 203 is coupled to the social network analytics modeller 202 and data storage 204 for displaying and analyzing the social segments and churning prediction scores. The data storage is coupled to the social network analytics modeller for receiving and storing the social segments and churn prediction scores. The input data comprises call detail record (CDR) from external source, and one or more information from campaigns and demographics.

In one embodiment, the data integration module 201 accesses data from multiple sources such as a data warehouse and CDR file database and integrates the accessed data into a required format based on a set of business rules. The social network analytics modeller 202 derives social segments and computes churn prediction scores from the integrated data. The social network analytics modeller 202 stores the social segments and churn prediction scores in data storage. The social network analytics visualiser 203 displays and analyses the social segments and churn prediction scores.

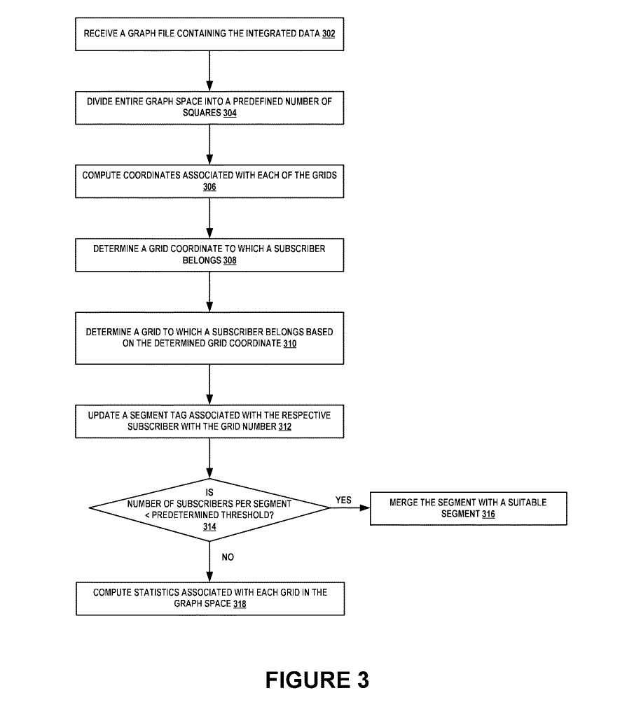

FIG. 3 is a process flowchart illustrating an exemplary method of generating statistics of social segments from the integrated data by the social network analytics modeller, according to one embodiment. At step 302, a graph file containing the integrated data is received from the data integration module. The integrated data is assumed to be in a space aligned format as in standard systems like Gephi. At step 304, entire graph space is divided into a pre-defined number of squares. In some embodiments, the graph space is divided into default number of grids. In other embodiments, the graph space is divided into a number of grids pre-defined by the user.

At step 306, coordinates associated with each of the grids are computed. At step 308, a gird coordinate to which a subscriber belongs is determined for each of the subscribers. At step 310, a grid to which each subscriber belongs to is determined based on the determined grid coordinate. At step 312, a segment tag associated with the respective subscriber is updated with the grid number.

At step 314, for each segment, it is determined whether the number of subscribers in a segment is less than a pre-defined threshold. In some embodiments, the predefined threshold may be minimum size of segment (i.e., the minimum number of subscribers per segment). If the number of subscribers in the segment is less than the pre-defined threshold, at step 316, then the segment is merged with a suitable segment. If the number of subscribers in the segment is not less than the pre-determined threshold, then step 318 is performed.

At step 318, the statistics associated with each grid in the graph space is computed. The statistics may include size of the grid, churn percentage for the grid, average churn. For each grid, the size of the grid is computed based on the number of subscribers in the grid. The churn percentage (α) is computed by dividing the number of churn in the segment by number of subscribers in the segment. Then, the average churn (μ) is computed based on the equation:

$$μ = {\sum }_{i = 1}^{i = n} {α}_{i} / n$$

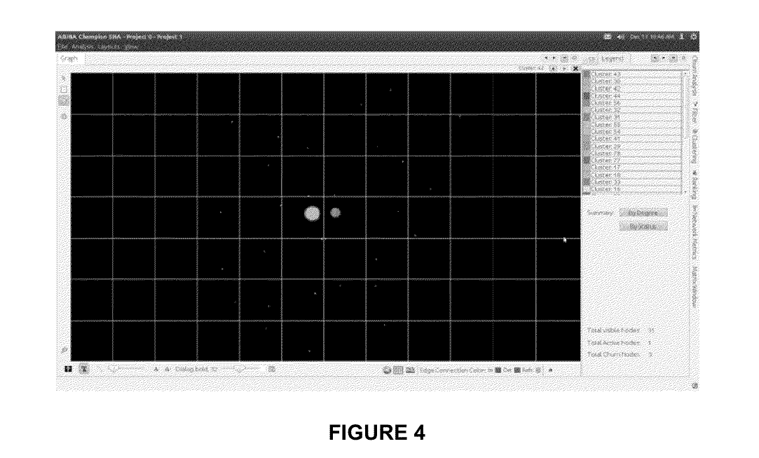

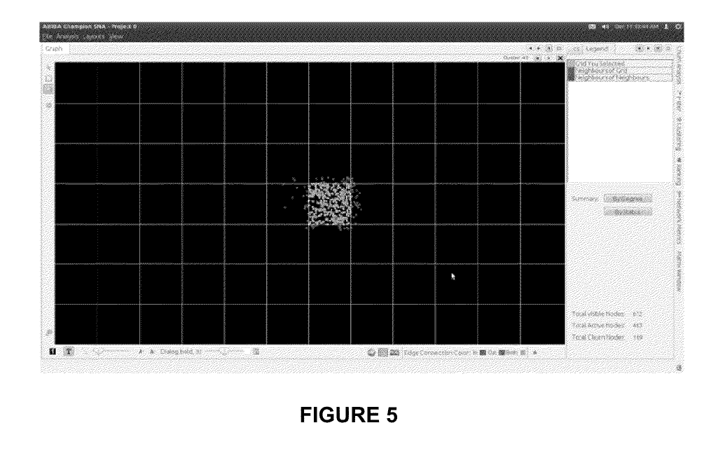

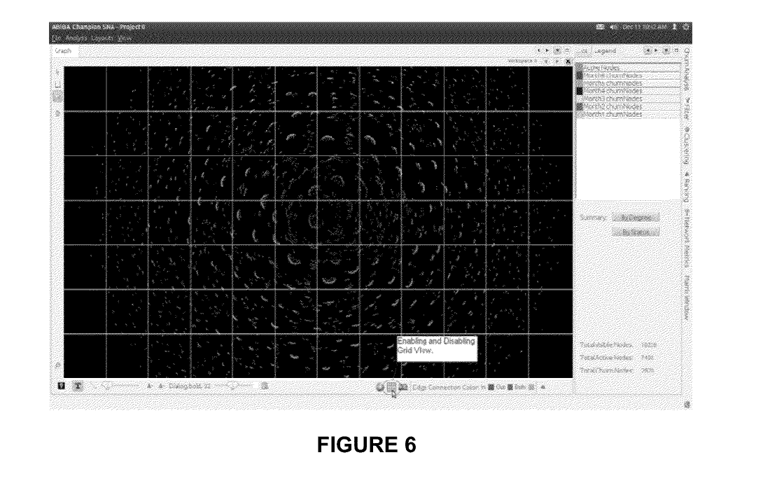

The size of the grid is represented as a circle with a suitable diameter and highlighted using a pre-defined colour. The diameter of the circle to represent a grid is computed based on the number of subscribers in the grid. The colour of the circle is determined by computing a colour index (Cᵢ) on a three color scale as defined by the user. The colour index (Cᵢ) is computed by dividing the churn percentage by the average churn. The statistics computed at step 318 is displayed as shown in FIG. 4. Further, the detailed list of all the subscribers or in desired segment can be drilled down from the statistics displayed in FIG. 4 as illustrated in FIGS. 5 and 6.

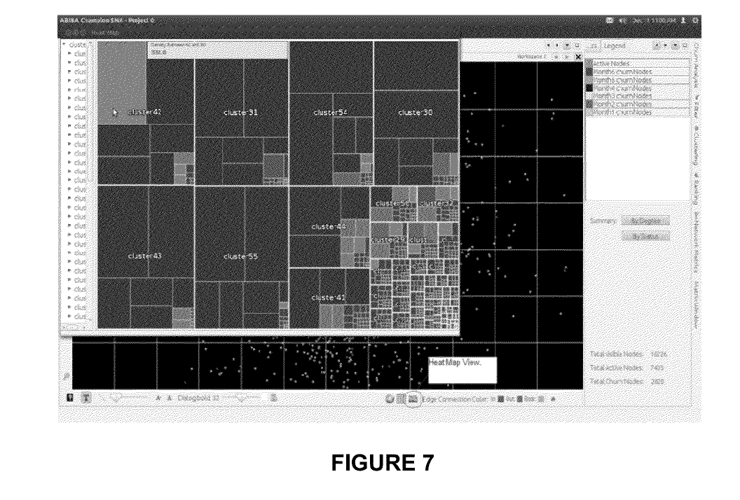

Additionally, multiple segments can be clustered using pre-defined set of rules. The derived segments from the clustering can be analysed using heat map or a tree map as shown in FIG. 7. The heat map or tree map is a rectangular grid arrangement of elements based on the size.

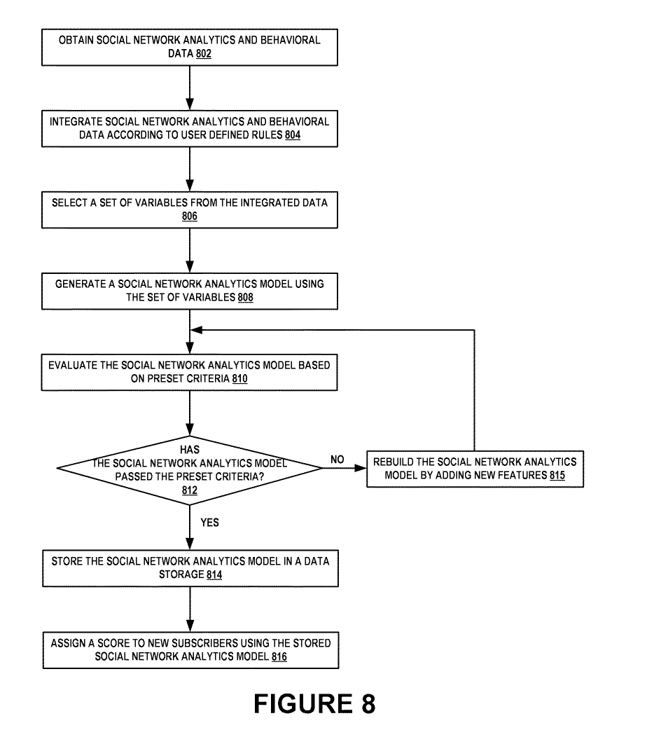

FIG. 8 is a process flowchart illustrating an exemplary method of generating a social network analytics model and computing a churn propensity score by the social network analytics modeller, according to one embodiment. At step 802, social network analytics data and behavioural data is obtained from the data storage and the data warehouse respectively. At step 804, the social network analytics data and the behavioural data is integrated according to user defined rules. At step 806, a set of variables is selected from the integrated data for generating a model. The set of variables are identifier using algorithm such as decision tree or chi-squared tree. At step 808, a model is generated using the set of variables. In some embodiments, a Naïve Bayesian Classifier algorithm is used to generate a social network analytics model based on the set of variables. The Naïve Bayesian Classifier helps to learn relationship between the set of variables likely to cause churn and actual status of each subscriber at any point of time.

At step 810, the social network analytics model is evaluated based on preset criteria (e.g., classification accuracy, true positive to false positive ratio, Lift and Decline effectiveness). At step 812, it is determined whether the social network analytics model has passed the preset criteria. If the social network analytics model has passed the preset criteria, then at step 814, the social network analytics model is stored in the data storage for scoring and further analysis (e.g., campaigning/retention/marketing). If the social network analytics model failed to meet the preset criteria, then the social network analytics model is rebuilt by adding new features at step 815 and steps 810 and 812 are repeated till the social network analytics model passes the preset criteria. At step 816, a score (e.g., a churn propensity score) are assigned to new subscribers using the social network analytics model stored in the data storage. The score associated with the new subscriber is used for further analysis and decision making.

Although the invention of the system and method has been described in connection with the embodiments of the present invention illustrated in the accompanying drawings, it is not limited thereto. It will be apparent to those skilled in the art that various substitutions, modifications and changes may be made thereto without departing from the scope and spirit of the invention.

We claim:

1. A mobile social network analytic system, the system comprising:
a data integration module configured for receiving and integrating a set of input data;
a social network analytics modeller coupled to the data integration module for processing the integrated data and deriving social segments and computing churn prediction scores; and
a social network analytics visualizer coupled to the social network analytics modeller and a data storage for displaying and analysing the social segments and churning prediction scores.

2. The system as claimed in claim 1, wherein the input data comprises call detail record (CDR) from external source, and one or more information from campaigns and demographics.

3. The system as claimed in claim 1 further comprising one or more external sources for providing input data to the data integration module.

4. The system as claimed in claim 3, wherein the external source comprises at least one of a data warehouse and core file database.

5. The system as claimed in claim 1, wherein the data storage is coupled to the social network analytics modeller for receiving and storing the social segments and churn prediction scores.

6. A method of generating statistics of social segments and churn prediction scores, the method comprising:
integrating a set of input data received from an external source to generate a graph;
dividing the entire space of the graph into a number of grids;
computing coordinates associated with each of the grids;
determining grid coordinates associated with each subscriber;
determining the grids associated with the subscribers based on the determined grid coordinates;
updating a segment tag associated with each subscriber with the grid number;
merging the segment with another segment when number of subscribers per segment being less than predetermined number of subscribers; and
computing statistics associated with each grid in the graph space when number of subscribers per segment being not less than predetermined number of subscribers.

7. The method as claimed in claim 6, wherein the set of input data comprises call detail record (CDR) from external source, and one or more information from campaigns and demographics.

8. A method of generating a social network analytics model and computing a churn propensity score by the social network analytics system, the method comprising:
obtaining social network analytic data and behavioural data from a data storage and the data warehouse;
integrating the social network analytics data and the behavioural data according to user defined configuration;
generating one or more models based on the selection of variables;
evaluating the social network analytic model based on a pre-set criteria;
determining whether the social network analytic model conforms to the pre-set criteria;
rebuilding the social network analytics model by adding new features when the determination fails to conform the pre-set criteria;
storing the social network analytics model in the data storage when the determination conforms the pre-set criteria; and
assigning a score to new subscribers using the stored social network analytics model.

9. The method as claimed in claim 8, wherein the pre-set criteria comprises classification accuracy, true positive to false positive ratio, lift and decline effectiveness.
